(19) United States
(12) Patent Application Publication
(10) Pub. No.: US 2015/0099497 A1
(43) Pub. Date: Apr. 9, 2015

(54) MOBILE DEVICE AND METHOD FOR DISPLAYING INCOMING CALL OF MOBILE DEVICE

(71) Applicant: Chiun Mai Communication Systems, Inc., New Taipei (TW)

(72) Inventor: HSIN-YUNG SHAO, New Taipei (TW)

(21) Appl. No.: 14/510,124

(22) Filed: Oct. 9, 2014

(30) Foreign Application Priority Data
Oct. 9, 2013 (CN) 201310465443.3

(51) Int. Cl. H04M 3/42; H04W 4/16

(52) U.S. Cl. CPC H04M 3/42042; H04W 4/16
USPC 455/415

(57) ABSTRACT

In a method for displaying an incoming call of a mobile device, one or more application software of the mobile device are set for providing information of a caller of the incoming call. A name of the caller is retrieved from an address book of the mobile device according to a calling number of the incoming call. Information related to the name of the caller is retrieved from each of the application software. The retrieved information is displayed on a display screen of the mobile device.

### CROSS-REFERENCE TO RELATED APPLICATIONS

This application claims priority to Chinese Patent Application No. 201310465443.3 filed on Oct. 9, 2013, the contents of which are incorporated by reference herein.

### FIELD

Embodiments of the present disclosure relate to an incoming call display technology, and more specifically to a mobile device and a method for displaying an incoming call of the mobile device.

### BACKGROUND

When a mobile phone receives an incoming call, information about a caller of the incoming call is displayed on a display screen of the mobile phone. The information can be a name and an image of the caller. However, the information cannot suggest to a user of the mobile phone which conversation the user is likely to need during the call. More information for suggesting to the user needs to be displayed on the display screen.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a mobile device including a displaying system.

FIG. 2 is a block diagram of one embodiment of function modules of the displaying system in the mobile device in FIG. 1.

FIG. 3 illustrates a flowchart of one embodiment of a method for displaying an incoming call of the mobile device in FIG. 1.

FIG. 4 is a diagrammatic view of a display screen of the mobile device for displaying information relevant to an incoming call.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

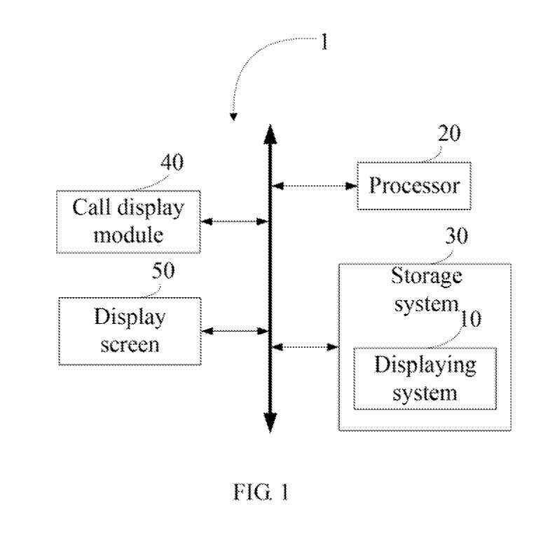

FIG. 1 illustrates a block diagram of one embodiment of a mobile device 1. Depending on the embodiment, the mobile device 1 includes a displaying system 10. In one embodiment, the mobile device 1 can be a personal digital assistant device, a mobile phone, or any other mobile device. The mobile device 1 further includes, but is not limited to, at least one processor 20, a storage system 30, a call display module 40, and a display screen 50.

The call display module 40 includes a frequency-shift keying (FSK) modulation and demodulation chip (hereinafter to be referred as “FSK chip”) or a dual-tone multi-frequency signaling (DTMF) modulation and demodulation chip (hereinafter to be referred as “DTMF chip”). When the mobile device 1 receives an incoming call, the call display module 40 receives a FSK signal or a DTMF signal of the incoming call from a base station (not shown in FIG. 1) which can communicate with the mobile device, and the FSK chip demodulates the FSK signal or the DTMF chip demodulates the DTMF chip to obtain a calling number of the incoming call. The FSK signal or the DTMF signal comprises, but is not limited to, the calling number of the incoming call, and a date and time indicating that the mobile device 1 receives the incoming call. The calling number of the incoming call can be a phone number corresponding to the incoming call, for example, a phone number of a mobile phone. The mobile phone generates the incoming call to the mobile device.

The display screen 50 displays information of the incoming call of the mobile device 1. In one embodiment, the information of the incoming call comprises, but is not limited to, a name of a caller making the incoming call, an image of the caller, and data from a plurality of application software (not shown in FIG. 1) of the mobile device 1. Each of the application software has a record of data related to the name of the caller of the incoming call. The application software comprises, but is not limited to, a calendar, a memo pad, and an email box of the mobile device 1.

In at least one embodiment, the storage system 30 can include various types of non-transitory computer-readable storage media. For example, the storage system 30 can be an internal storage system, such as a flash memory, a random access memory (RAM) for temporary storage of information, and/or a read-only memory (ROM) for permanent storage of information. The storage system 30 can also be an external storage system, such as a hard disk, a storage card, or a data storage medium. The at least one processor 20 can be a central processing unit (CPU), a microprocessor, or other data processor chip that performs functions of the mobile device 1.

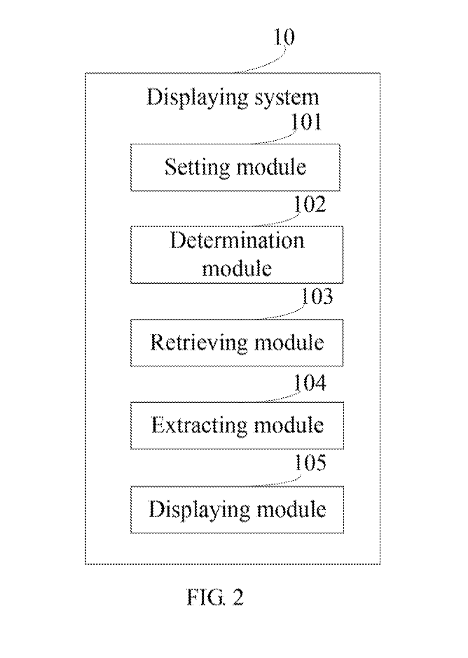

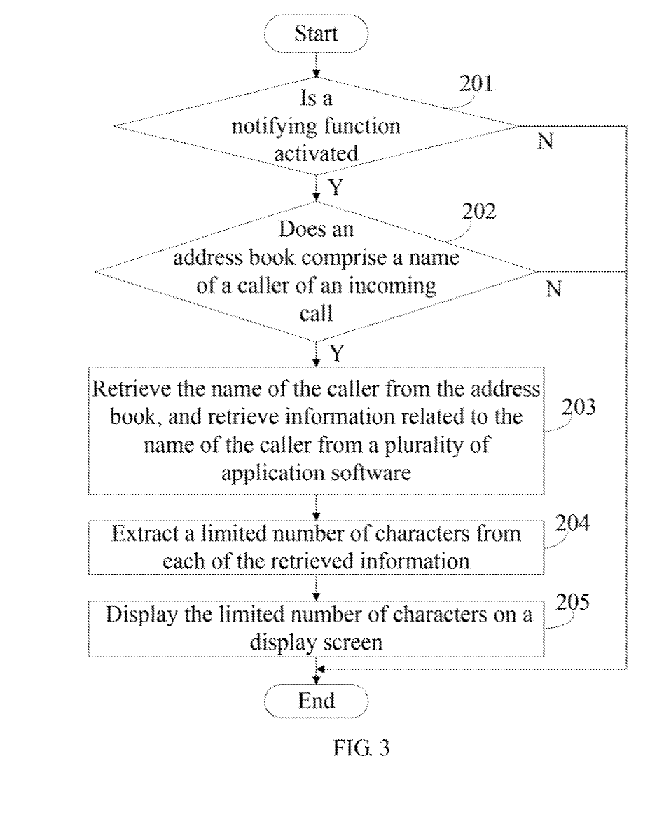

FIG. 2 is a block diagram of one embodiment of function modules of the displaying system 10. In at least one embodiment, the displaying system 10 can include a setting module 101, a determination module 102, a retrieving module 103, an extracting module 104, and a displaying module 105. The function modules 101-105 can include computerized code in the form of one or more programs, which are stored in the storage system 30. The at least one processor 20 executes the computerized code to provide functions of the function modules 101-105. More particular details of the function modules 101-105 are given in FIG. 3.

Referring to FIG. 3, a flowchart is presented in accordance with an example embodiment. The example method is provided by way of example, as there are a variety of ways to carry out the method. The method described below can be carried out using the configurations illustrated in FIG. 1 and FIG. 2, for example, and various elements of these figures are referenced in explaining example method. Each block shown in FIG. 3 represents one or more processes, methods, or subroutines, carried out in the exemplary method. Additionally, the illustrated order of blocks is by example only and the order of the blocks can be changed. The exemplary method can begin at block 201. Depending on the embodiment, additional blocks can be added, others removed, and the ordering of the blocks can be changed.

In block 201, a determination module determines whether a notifying function is activated. In one embodiment, the notifying function is used for retrieving information from a plurality of application software of a mobile device when the mobile device receives an incoming call. When the notifying function is activated, block 202 is executed. When the notifying function is not activated, the procedure is ended, and the mobile device does not retrieve information from the application software and displays the incoming call on a display screen of the mobile device in a normal way. In the embodiment, the mobile device activates a caller identification service for identifying a calling number of the incoming call. For identifying the calling number of the incoming call, a call display module of the mobile device receives a FSK signal or a DTMF signal of the incoming call from a base station communicating with the mobile device, and demodulates the FSK signal or the DTMF signal to retrieve the calling number of the incoming call.

In one embodiment, when the mobile device displays the incoming call on the display screen in the normal way, the mobile device determines whether a name of a caller of the incoming call is included in an address book of the mobile device according to the calling number of the incoming call. The mobile device displays the name of the caller of the incoming call on a display screen of the mobile device when the name of the caller of the incoming call is included in the address book of the mobile device. The mobile device displays only the calling number of the incoming call on the display screen when the name of the caller of the incoming call is not included in the address book of the mobile device. At the same time, the mobile device prompts a user of the mobile device to receive the incoming call.

Each of the application software has a record of data related to the name of the caller of the incoming call. In one embodiment, the application software comprises, but is not limited to, a calendar, a memo pad, and an email box of the mobile device. The calendar of the mobile device records previous arrangements related to the name of the caller of the incoming call. The memo pad of the mobile device records notes related to the name of the caller of the incoming call. The email box of the mobile device records one or more emails related to the name of the caller of the incoming call.

In block 202, a setting module sets the application software for providing information of the caller of the incoming call, and the determination module determines whether the address book of the mobile device comprises the name of the caller according to the calling number of the incoming call. When the address book of the mobile device comprises the name of the caller, block 203 is executed. When the address book of the mobile device does not comprise the name of the caller, the procedure is ended, the calling number of the incoming call is simply displayed on the display screen, and the user of the mobile device is prompted to receive the incoming call.

In block 203, a retrieving module retrieves the name of the caller from the address book of the mobile device according to the calling number of the incoming call, and retrieves information related to the name of the caller from each application software. In the embodiment, the retrieving module searches the information related to the name of the caller in each application software, and retrieves the information related to the name of the caller from one of the application software when the one of the application software comprises the information related to the name of the caller.

The information recorded by the application software can be created or modified at any time. In one embodiment, a predetermined time interval is applied to a creation time or a modification time of the retrieved information. That is, information which has been created or modified within the predetermined time interval is retrieved. The predetermined time interval can be determined by the user of the mobile device or can be preset by a factory of the mobile device. For example, the predetermined time interval can be preset as several days (e.g., four days), and only information which has been created or modified within the predetermined time interval can be retrieved from the application software.

In one embodiment, when the number of the retrieved information from an application software is more than one, the retrieving module further retrieves information that the creation time or the modification time is at the latest. For example, when the email box has two emails related to the name of caller and creation times of the two emails are Oct. 10, 2014 and Oct. 9, 2014 respectively, the retrieving module retrieves information of an email that the creation time is Oct. 10, 2014.

In one embodiment, data of each of the application software is stored to a folder of a storage system of the mobile device. The retrieving module retrieves information from a folder corresponding to each of the application software. For example, when the name of the caller of the incoming call is Wang San, the retrieving module retrieves information related to Wang San from a folder corresponding to the calendar, from a folder corresponding to the memo pad, and from a folder corresponding to the email box.

In block 204, an extracting module extracts a limited number of characters from each of the retrieved information. The limited number of characters can be determined by the user of the mobile device or can be preset by a factory of the mobile device. For example, the limited number of characters can be set as fifty.

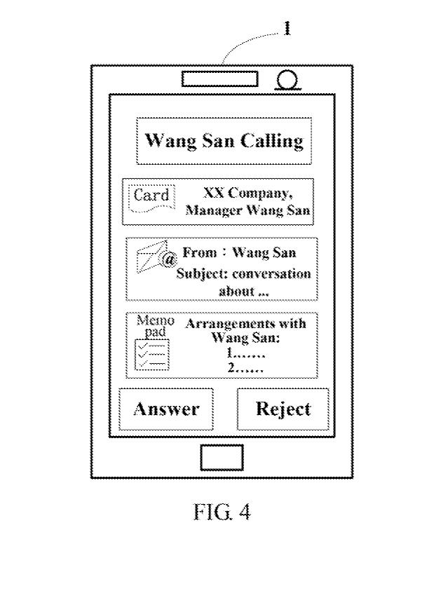

In block 205, a displaying module displays the limited number of characters on the display screen. In one embodiment, the limited number of characters from each application software is displayed in an independent display area on the display screen. As the example in FIG. 4 shows, the limited number of characters corresponding to the calendar, to the memo pad, and to the email box is displayed in different display areas on the display screen.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for displaying an incoming call of a mobile device, the method comprising:
setting a plurality of application software of the mobile device to provide information of a caller of the incoming call;
retrieving a name of the caller from an address book of the mobile device according to a calling number of the incoming call;
retrieving information related to the name of the caller from each of the plurality of application software; and
displaying the retrieved information on a display screen of the mobile device.

2. The method according to claim 1, further comprising:
determining whether a notifying function is activated for retrieving information from the plurality of application software when the mobile device receives the incoming call.

3. The method according to claim 1, further comprising:
determining whether the address book of the mobile device comprises the name of the caller according to the calling number of the incoming call.

4. The method according to claim 1, wherein displaying the retrieved information on the display screen comprises:
extracting a limited number of characters from each of the retrieved information; and
displaying the limited number of characters on the display screen.

5. The method according to claim 1, wherein information that has been created or modified in a predetermined time interval is retrieved.

6. The method according to claim 1, wherein the plurality of application software comprise a calendar, a memo pad, and an email box of the mobile device.

7. A mobile device for displaying an incoming call, the mobile device comprising:
a display screen;
a processor; and
a storage system that stores one or more programs, when executed by the at least one processor, cause the at least one processor to:
set a plurality of application software of the mobile device to provide information of a caller of the incoming call;
retrieving a name of the caller from an address book of the mobile device according to a calling number of the incoming call;
retrieving information related to the name of the caller from each of the plurality of application software; and
display the retrieved information on the display screen.

8. The mobile device according to claim 7, wherein the one or more programs further cause the at least one processor to:
determine whether a notifying function is activated for retrieving information from the plurality of application software when the mobile device receives the incoming call.

9. The mobile device according to claim 7, wherein the one or more programs further cause the at least one processor to:
determine whether the address book of the mobile device comprises the name of the caller according to the calling number of the incoming call.

10. The mobile device according to claim 7, wherein displaying the retrieved information on the display screen comprises:
extracting a limited number of characters from each of the retrieved information; and
displaying the limited number of characters on the display screen.

11. The mobile device according to claim 7, wherein information that has been created or modified in a predetermined time interval is retrieved.

12. The mobile device according to claim 7, wherein the plurality of application software comprise a calendar, a memo pad, and an email box of the mobile device.

13. A non-transitory storage medium having stored thereon instructions that, when executed by a processor of a mobile device, causes the processor to perform a method for displaying an incoming call of the mobile device, wherein the method comprises:
setting a plurality of application software of the mobile device to provide information of a caller of the incoming call;
retrieving a name of the caller from an address book of the mobile device according to a calling number of the incoming call;
retrieving information related to the name of the caller from each of the plurality of application software; and
displaying the retrieved information on a display screen of the mobile device.

14. The non-transitory storage medium according to claim 13, wherein the method further comprises:
determining whether a notifying function is activated for retrieving information from the plurality of application software when the mobile device receives the incoming call.

15. The non-transitory storage medium according to claim 13, wherein the method further comprises:
determining whether the address book of the mobile device comprises the name of the caller according to the calling number of the incoming call.

16. The non-transitory storage medium according to claim 13, wherein displaying the retrieved information on the display screen comprises:
extracting a limited number of characters from each of the retrieved information; and
displaying the limited number of characters on the display screen.

17. The non-transitory storage medium according to claim 13, wherein information that has been created or modified in a predetermined time interval is retrieved.

18. The non-transitory storage medium according to claim 13, wherein the plurality of application software comprise a calendar, a memo pad, and an email box of the mobile device.
